(19) United States
(12) Patent Application Publication
(10) Pub. No.: US 2021/0379558 A1
(43) Pub. Date: Dec. 9, 2021

(54) RADIATION-ASSISTED NANOSTRUCTURE SYNTHESIS AND COMPOSITIONS THEREOF

(71) Applicant: University of Washington, Seattle, WA (US)

(72) Inventors: Vincent Holmberg, Seattle, WA (US); Elena Pandres, Seattle, WA (US); Peter J. Pauzauskie, Seattle, WA (US); Matthew J. Crane, Seattle, WA (US); E. James Davis, Seattle, WA (US)

(73) Assignee: University of Washington, Seattle, WA (US)

(21) Appl. No.: 17/287,077

(22) PCT Filed: Oct. 30, 2019
(86) PCT No.: PCT/US2019/058843

§ 371 Date: Apr. 20, 2021

Related U.S. Application Data
(60) Provisional application No. 62/753,026, filed on Oct. 30, 2018.

(51) Int. Cl. B01J 19/12; C01B 19/00; B22F 9/24

(52) U.S. Cl. CPC B01J 19/121; C01B 19/007; B22F 9/24; B01J 2219/089; B22F 2301/30; C01P 2004/16; C01P 2002/54; C01P 2004/54; B01J 2219/12

(57) ABSTRACT

The present disclosure describes radiation-assisted, substrate-free, and solution-based nanostructure (e.g., a nanotube and/or a nanowire (NW)) growth processes. The processes use the high absorption coefficient and high density of free charge carriers in particle seeds (e.g., nanoparticles, metal nanoparticles, and/or metal nanocrystals) to photothermally drive semiconductor nanostructure growth. The processes can be performed at atmospheric pressure, without specialized equipment such as specialized heating equipment and/or high-pressure reaction vessels.

### CROSS-REFERENCE(S) TO RELATED APPLICATION(S)

This application claims the benefit of U.S. Patent Application No. 62/753,026, filed Oct. 30, 2018, the disclosure of which is incorporated herein by reference in its entirety.

### STATEMENT OF GOVERNMENT LICENSE RIGHTS

This invention was made with government support under Grant No. DMR1719797, awarded by the National Science Foundation. The government has certain rights in the invention.

### BACKGROUND

The ability to synthesize nanostructures, such as nanowires and nanotubes, with complex compositions as well as produce nanostructures through scalable, solution-based processes, can be useful in a wide range of technological applications. For example, the optical, mechanical, and electronic characteristics of semiconductor nanostructures, such as nanowires (NWs), have resulted in a surge of research surrounding their production and use in sensing, energy conversion, and energy storage applications. The synthesis of semiconductor NWs generally follows one of two paradigms: top-down or bottom-up. Top-down syntheses, which remove material to produce NWs, are useful in applications that rely on precise placement, but top-down syntheses result in a large amount of material waste. Conversely, bottom-up syntheses, such as metal-seeded NW growth, add atoms via the decomposition of small-molecule semiconductor precursors. Bottom-up syntheses can provide complex compositional tunability, including the production of radial and axial heterostructures, often unavailable to top-down methods. Bottom-up synthesis methods can include metal-seeded NW growth, such as vapor-liquid-solid (VLS), solution-liquid-solid (SLS), and supercritical fluid-liquid-solid growth (SITS), based on nanoscale-induced melting point depression.

Generally, fluid-based nanostructure syntheses require specialized heating equipment and/or high-pressure reaction vessels that rely on resistive, isothermal heating of the bulk solvent. For example, in SLS growth, nanostructure precursors are added to a high boiling point solvent in a three-neck flask and the reaction is initiated when the round bottom flask is heated via a heating mantle, oil bath, or sand bath. Similarly, for supercritical fluid-based nanostructure (e.g., nanowires) growth, the reactor body is placed in a heating block to heat the nanostructure precursor solution (a mix of metal nanocrystals and semiconductor precursor) that is introduced into the reactor. In conventional solution-based nanostructure growth, a bulk solution containing nanocrystal seeds and semiconductor small molecule precursors are heated in an oxygen-free organic solvent. At sufficiently high temperatures, small molecule precursors decompose, and the semiconductor atoms form a eutectic alloy with the metal nanocrystal seeds. The alloy droplet rapidly supersaturates and nucleates crystalline semiconductor nanostructures with diameters governed by the seed particles in an isothermal process.

There is a need for facile, photothermally-driven nanostructure growth processes, for example, in solution-based systems. The present disclosure fulfils these needs and provides further advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect; the present disclosure features a method of growing a nanostructure, including: suspending a plurality of particles in a fluid; providing a soluble nanostructure precursor in the fluid; irradiating at least one particle with an incident electromagnetic radiation having a wavelength of from 300 nm to 15,000 nm; and reacting the soluble nanostructure precursor to grow a nanostructure from a surface of the irradiated particle. The plurality of particles is configured to absorb the incident electromagnetic radiation and to transduce the electromagnetic radiation to localized heat. The plurality of particles includes nanoparticles, microparticles, or a combination thereof. The nanostructure includes a nanowire; a nanotube, or a combination thereof.

In another aspect, the present disclosure features a method of growing a nanostructure, including continuously flowing a fluid through a reactor, the fluid including a plurality of particles and a nanostructure precursor; irradiating at least one particle with an incident electromagnetic radiation having a wavelength of from 300 nm to 15,000 nm at a predetermined location in the reactor, and reacting the nanostructure precursor to grow a nanostructure from a surface of the irradiated particle. The plurality of particles is configured to absorb the incident electromagnetic radiation and to transduce the electromagnetic radiation to heat. The nanostructure includes a nanowire, a nanotube, or a combination thereof.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1A is a TEM image of an embodiment of particles of the present disclosure.

FIG. 1B is a histogram of the diameter distribution of the particles of FIG. 1A,

FIG. 1C is an extinction spectrum of the particles of FIG. 1A used to synthesize an embodiment of nanowires of the present disclosure.

FIG. 2A is a TEM image of an embodiment of particles of the present disclosure.

FIG. 2B is a histogram of the diameter distribution of the particles of FIG. 1A.

FIG. 2C is an extinction spectrum of the particles of FIG. 1A used to synthesize an embodiment of nanowires of the present disclosure.

FIG. 3A is a series of thermal infrared images in neat octadecene under laser irradiation (1070 nm, 15 W).

FIG. 3B is a series of thermal infrared images of a cuvette containing an embodiment of particles of the present disclosure in octadecene under laser irradiation (1070 nm, 15 W).

FIG. 3C is a series of thermal infrared images of a cuvette containing an embodiment of particles of the present disclosure in octadecene under laser irradiation (1070 nm, 15 W).

FIG. 3D is a series of thermal infrared images of a cuvette containing an embodiment of particles of the present disclosure in octadecene under laser irradiation (1070 nm, 15 W).

FIG. 3E is a series of thermal infrared images of a cuvette containing precursors and octadecene under laser irradiation (1070 nm, 15 W).

FIG. 3F is a series of thermal infrared images of a cuvette containing nanostructure precursors, octadecene, and an embodiment of particles of the present disclosure under laser irradiation (1070 nm, 15 W).

FIG. 3G is a series of thermal infrared images of a cuvette containing nanostructure precursors, octadecene, and an embodiment of particles of the present disclosure under laser irradiation (1070 nm, 15 W).

FIG. 3H is a series of thermal infrared images of a cuvette containing nanostructure precursors, octadecene, and an embodiment of particles of the present disclosure under laser irradiation (1070 nm, 15 W).

FIG. 4A-4C is a schematic illustration of contact-free, laser-driven colloidal semiconductor nanostructure growth on the benchtop, in a quartz cuvette, specifically:

FIG. 4A is a schematic illustration of a cuvette including particle seeds and an embodiment of a nanostructure precursor suspended in a fluid;

FIG. 4B is a schematic illustration of the cuvette of FIG. 1A irradiated with a broad, unfocused electromagnetic radiation; and

FIG. 4C is a schematic illustration of an embodiment of a nanostructure on a particle seed surface, produced from the nanostructure precursor.

FIG. 5A is an infrared thermal image of a temperature distribution of a laser-irradiated suspension of particles ((OD_{1070 nm}=0.52) in a cuvette at 0 second. The temperature label corresponds to the maximum temperature recorded in the image.

FIG. 513 is an infrared thermal image of a temperature distribution of a laser-irradiated suspension of particles ((OD_{1070 nm}=0.52) in a cuvette at 30 seconds. The temperature label corresponds to the maximum temperature recorded in the image.

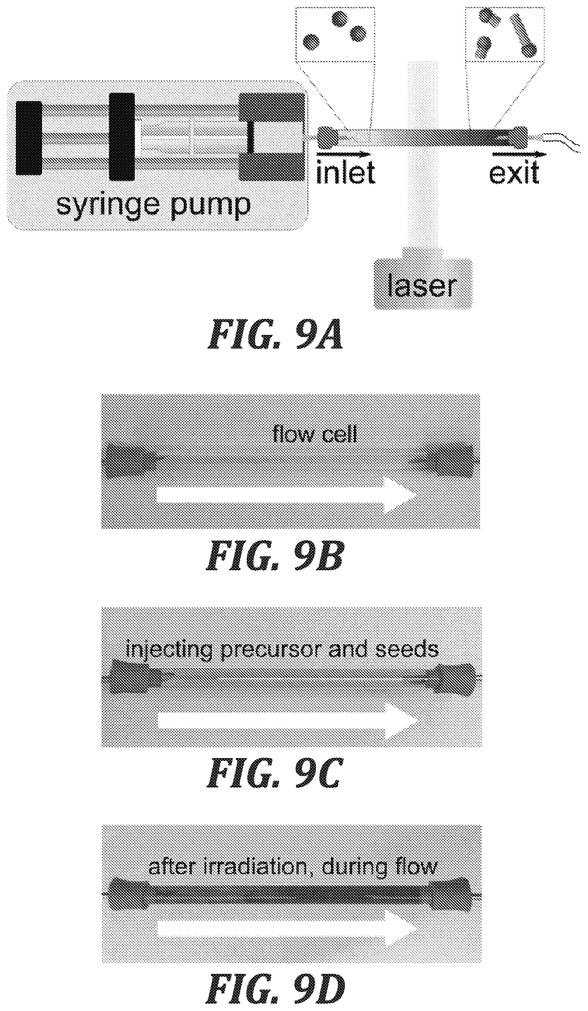

FIG. 5C is an infrared thermal image of a temperature distribution of a laser-irradiated suspension of particles ((OD_{1070 nm}=0.52) in a cuvette at 120 seconds. The temperature label corresponds to the maximum temperature recorded in the image.

FIG. 5D is an infrared thermal image of a temperature distribution of a laser-irradiated suspension of particles ((OD_{1070 nm}=0.52) in a cuvette at 540 seconds. The temperature label corresponds to the maximum temperature recorded in the image.

FIG. 5E is an infrared thermal image of a temperature distribution of a laser-irradiated neat octadecene in a cuvette at 0 second. The irradiation conditions are the same as for the sample in FIG. 5A. The temperature label corresponds to the maximum temperature recorded in the image.

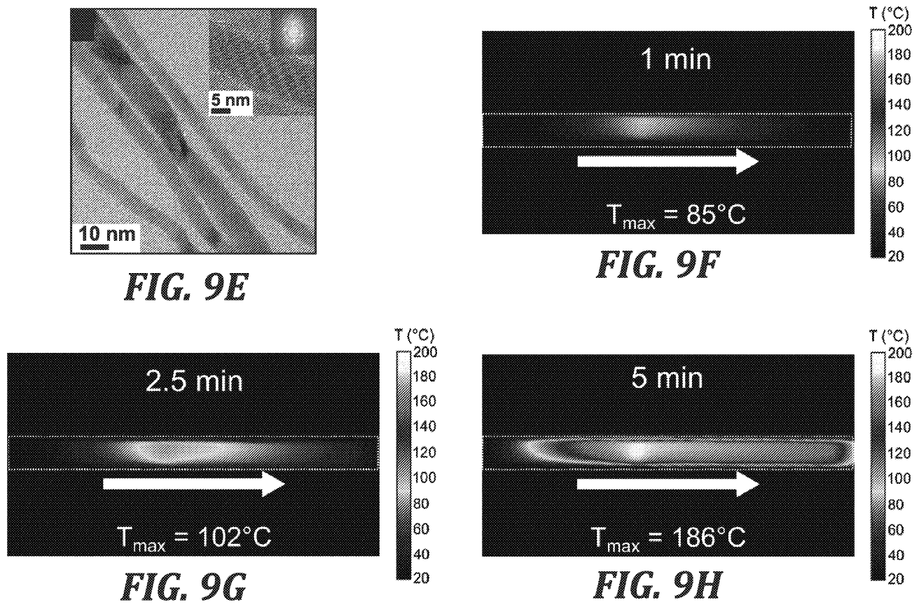

FIGURE SF is an infrared thermal image of a temperature distribution of a laser-irradiated neat octadecene in a cuvette at 30 seconds. The irradiation conditions are the same as for the sample in FIG. 513. The temperature label corresponds to the maximum temperature recorded in the image.

FIG. 5G is an infrared thermal image of a temperature distribution of a laser-irradiated neat octadecene in a cuvette at 120 seconds. The irradiation conditions are the same as for the sample in FIG. 5C. The temperature label corresponds to the maximum temperature recorded in the image.

FIG. 5H is an infrared thermal image of a temperature distribution of a laser-irradiated neat octadecene in a cuvette at 540 seconds. The irradiation conditions are the same as for the sample in FIG. 5D, The temperature label corresponds to the maximum temperature recorded in the image.

FIG. 5I is a graph of time-dependent temperature profiles for a range of particle concentrations (OD1070=0.03-0.52) under 1070 nm irradiation (15 W).

FIG. 6A is an illustration of an embodiment of a nanostructure synthesis of the present disclosure.

FIG. 6B is a TEM image of an embodiment of a nanostructure of the present disclosure (e.g., narrow-diameter, wurtzite-phase CdSe nanowires), showing metal particle-seeded nanostructure growth.

FIG. 6C is a TEM image of an embodiment of a nanostructure of the present disclosure (e.g., narrow-diameter, wurtzite-phase CdSe nanowires), showing metal particle-seeded nanostructure growth.

FIG. 6D is a TEM image of an embodiment of a nanostructure of the present disclosure (e.g., narrow-diameter, wurtzite-phase CdSe nanowires), showing metal particle-seeded nanostructure growth.

FIG. 6E is an X-ray diffractogram of an embodiment of a nanostructure of the present disclosure, showing the presence of particle seed and crystalline cadmium and selenium. Both nanowire (highlighted with asterisks) and seed materials are indexed in the X-ray diffraction pattern.

FIG. 6F is a histogram of the diameter distribution of an embodiment of a nanostructure of the present disclosure (e.g., Bi-seeded CdSe nanowires).

FIG. 6G is a series of thermal infrared images of a cuvette containing nanostructure precursors, octadecene, and an embodiment of particles of the present disclosure under laser irradiation (1070 nm, 15 W).

FIG. 6H is a plot of time-dependent temperature profiles for different particle (e.g., Bi nanocrystals) concentrations (OD₁₀₇₀=0.03-0.52) with nanostructure precursors (e.g., CdSe precursors) under irradiation (1070 nm, 15 W).

FIG. 7A is an illustration of an embodiment of a nanostructure synthesis of the present disclosure.

FIG. 7B is a TEM image of an embodiment of a nanostructure of the present disclosure (e.g., diamond-cubic, Bi-seeded Ge nanowires), showing metal particle-seeded nanostructure growth.

FIG. 7C is a TEM image of an embodiment of a nanostructure of the present disclosure (e.g., diamond-cubic, Bi-seeded Ge nanowires), showing metal particle-seeded nanostructure growth.

FIG. 7D is a TEM image of an embodiment of a nanostructure of the present disclosure (e.g., diamond-cubic, Bi-seeded Ge nanowires), showing metal particle-seeded nanostructure growth.

FIG. 7E is an X-ray diffractogram of an embodiment of a nanostructure of the present disclosure, showing the presence of particle seed and crystalline germanium. Both nanowire (highlighted with asterisks) and seed materials are indexed in the X-ray diffraction pattern.

FIG. 7F is a histogram of a diameter distribution of an embodiment of a nanostructure of the present disclosure (e.g., Bi-seeded germanium nanowire).

FIG. 8A is an illustration of an embodiment of a nanostructure synthesis of the present disclosure.

FIG. 8B is a TEM image of an embodiment of a nanostructure of the present disclosure (e.g., Ge nanowires grown using In nanocrystal seeds), showing metal-seeded nanostructure growth.

FIG. 8C is a TEM image of an embodiment of a nanostructure of the present disclosure (e.g., Ge nanowires grown using In nanocrystal seeds), showing metal-seeded nanostructure growth.

FIG. 8D is a TEM image of an embodiment of a nanostructure of the present disclosure (e.g., Ge nanowires grown using In nanocrystal seeds), showing metal-seeded nanostructure growth.

FIG. 8E is an X-ray diffractogram of an embodiment of a nanostructure of the present disclosure, showing the presence of particle seed and crystalline germanium. Both nanowire (highlighted with asterisks) and seed materials are indexed in the X-ray diffraction pattern.

FIG. 8F is a histogram of a diameter distribution of an embodiment of a nanostructure of the present disclosure (e.g., In-seeded germanium nanowires).

FIG. 9A is a schematic illustration of a flow cell for continuous, laser-driven nanostructure growth under flow.

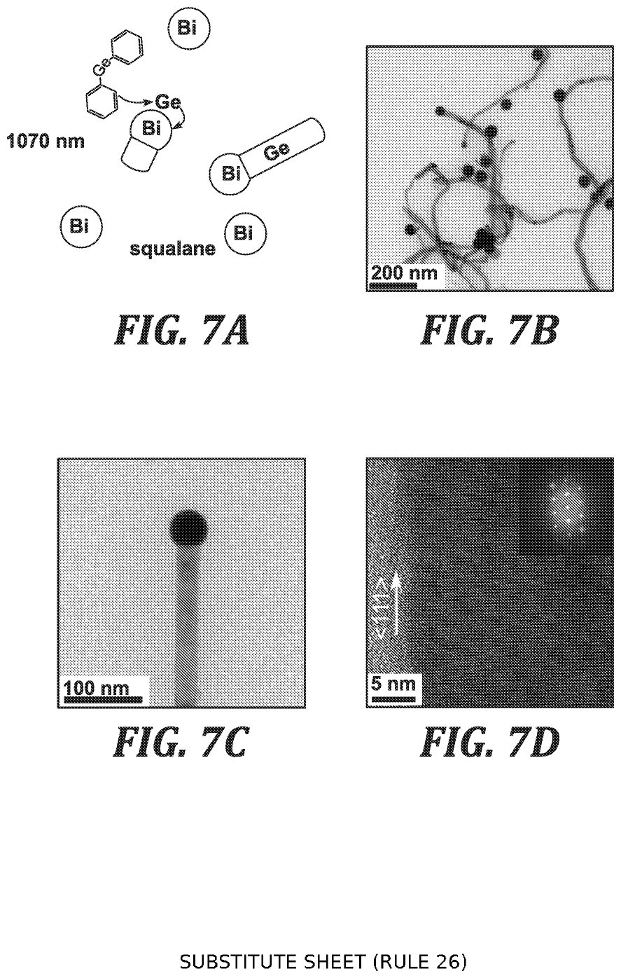

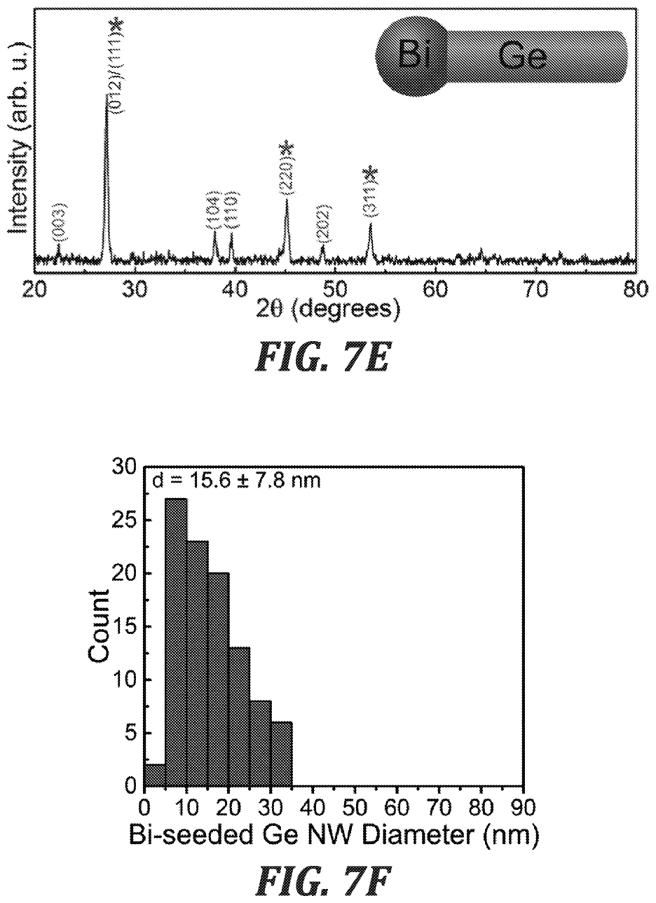

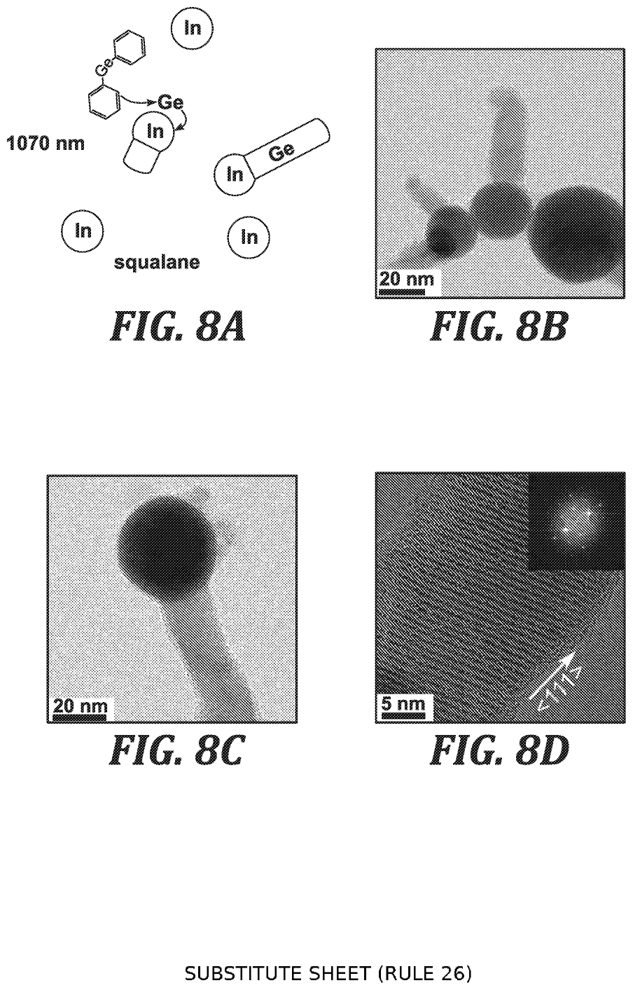

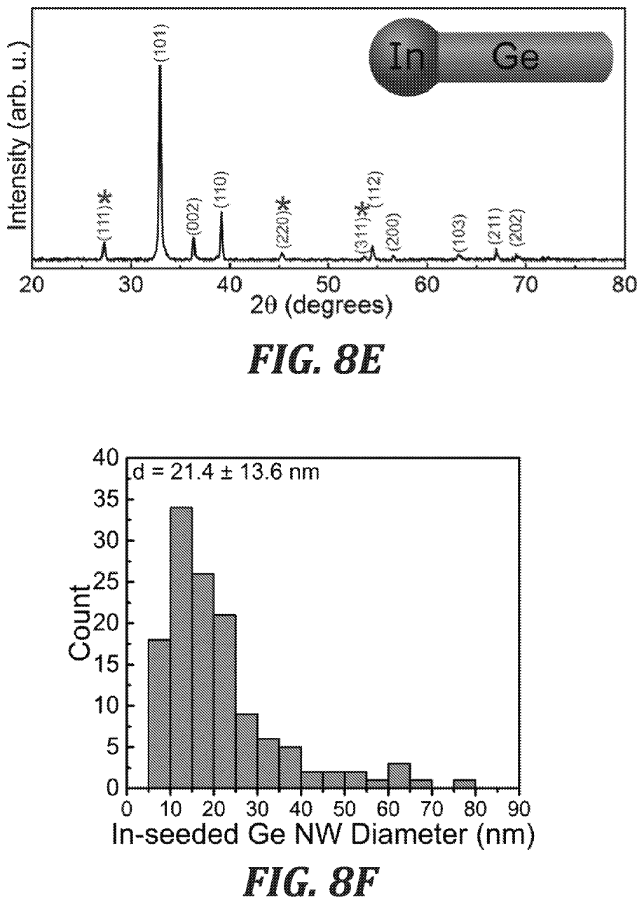

FIG. 9B is a photograph of a reaction zone in a flow cell of FIG. 4A containing a solvent.

FIG. 9C is a photograph of a reaction zone in a flow cell of FIG. 4B during injection of particle seeds and nanostructure precursors.

FIG. 9D is a photograph of a reaction zone in a flow cell of FIG. 4C after laser irradiation under flow.

FIG. 9E is a TEM image of an embodiment of a nanostructure of the present disclosure.

FIG. 9F is an infrared thermal image of a reaction zone of a flow cell of FIG. 9A after 1 minute of 1070 nm irradiation under flow (0.05 mL/min). Temperature label corresponds to the maximum temperature recorded in the image.

FIG. 9G is an infrared thermal image of a reaction zone of a flow cell of FIG. 9A after 2.5 minutes of 1070 nm irradiation under flow (0.05 mL/min). Temperature label corresponds to the maximum temperature recorded in the image.

FIG. 9H is an infrared thermal image of a reaction zone of a flow cell of FIG. 9A after 5 minute of 1070 nm irradiation under flow (0.05 mL/min). Temperature label corresponds to the maximum temperature recorded in the image.

### DETAILED DESCRIPTION

The present disclosure describes radiation-assisted, substrate-free, and solution-based nanostructure (e.g., a nanotube and/or a nanowire (NW)) growth processes. The processes use the high absorption coefficient and high density of free charge carriers in particle seeds (e.g., nanoparticles, metal nanoparticles, and/or metal nanocrystals) to photothermally drive semiconductor nanostructure growth. In the processes of the present disclosure, an incident electromagnetic light (e.g., a laser, a coherent narrow band light, a spectrally broadband light, a polarized light, an unpolarized light, coherent light, and/or incoherent light) is used to irradiate a solution containing particles and nanostructure precursors. The particles absorb the light and rapidly generate heat to induce nanostructure precursor decomposition and promote the growth of crystalline nanostructures. The processes can be performed at atmospheric pressure, without specialized equipment such as specialized heating equipment and/or high-pressure reaction vessels. For example, the processes can be carried out on a benchtop in a vessel including an optically transparent region, such as a vessel including a quartz window.

### Definitions

As used herein, a “particle seed” or a “particle” that is used to seed a nanostructure includes nanoparticles and microparticles. In some embodiments, the particle has a maximum diameter of from 2 nm to 1 μm.

As used herein, a “nanostructure” includes a nanowire and/or a nanotube. In some embodiments, the nanostructure is a nanowire. In certain embodiments, the nanostructure is a nanotube.

As used herein, “radiation” or “electromagnetic radiation” includes a laser, a coherent narrow band light, a spectrally broadband light, a polarized light, an unpolarized light, coherent light, and/or incoherent light. In some embodiments, the radiation or electromagnetic radiation is laser radiation.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims; the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize. Specific elements of any embodiments herein can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure. It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Furthermore, the particular arrangements shown in the FIGURES should not be viewed as limiting. It should be understood that other embodiments may include more or less of each element shown in a given FIGURE. Further; some of the illustrated elements may be combined or omitted. Yet further, an example embodiment may include elements that are not illustrated in the FIGURES.

As used herein, with respect to measurements, “about” means+1-5%. As used herein, a recited ranges includes the end points, such that from 0.5 mole percent to 99.5 mole percent includes both 0.5 mole percent and 99.5 mole percent.

### Radiation-Assisted Nanostructure Synthesis

The present disclosure features a method of growing a nanostructure, including suspending a plurality of particles in a fluid; providing a nanostructure precursor in the fluid; irradiating at least one particle with an incident electromagnetic radiation having a wavelength of from 300 nm to 15,000 nm; and reacting the soluble nanostructure precursor to grow a nanostructure from a surface of the irradiated particle. The electromagnetic radiation can include a laser, a coherent narrow band light, a spectrally broadband light, a polarized light, an unpolarized light, coherent light, and/or incoherent light. In some embodiments, the electromagnetic radiation is laser radiation. The plurality of particles is configured to absorb the incident electromagnetic radiation and to transduce the electromagnetic radiation to localized heat. The plurality of particles can include nanoparticles, microparticles, or a combination thereof. The plurality of particles is configured to serve as seeds for the nucleation and growth of nanostructures. The nanostructure that is synthesized can be in the form of a nanowire, a nanotube, or a combination thereof. Without wishing to be bound by theory; it is believed that nanotubes and/or nanowires can result depending on the precursor. For example, carbon nanotubes can be made by using toluene (which can simultaneously be the fluid and the nanostructure precursor), and silica nanotubes can be made using solvents that include a small fraction of water and oxygen.

In some embodiments, the particles have a maximum diameter of from 2 nm to 1 μm (e.g., from 2 nm to 500 nm, from 2 nm to 250 nm, from 2 nm to 100 nm, from 50 nm to 750 nm, from 50 nm to 500 nm, from 50 nm to 250 nm, from 50 nm to 100 nm, from 100 nm to 500 nm, from 100 nm to 200 nm, from 500 nm to 1000 nm, from 500 nm to 750 nm, or from 750 ran to 1000 nm). In some embodiments, the particles have a maximum diameter of from 2 nm to 100 nm. As used herein, a nanoparticle has a maximum diameter of less than 1 micron. As used herein, a microparticle has a maximum diameter of 1 micron (1000 nm) or more. Without wishing to be bound by theory, it is believed that a particle having a maximum diameter of greater than 50 nm can serve as a nucleation seed for multiple nanostructures growing from the same seed (e.g., nanowires and/or nanotubes).

The particles can be formed of or include any composition that can absorb an incident electromagnetic radiation and transduce the electromagnetic radiation to localized heat. For example, the particle can include a plasmonic semiconductor; a metal, a metal alloy, or any combination thereof. The particle can be crystalline. For example, the particle can be a nanocrystal (e.g., a metal nanocrystal). In some embodiments, the particles include a metal (e.g., silver (Ag), aluminum (Al), gold (Au), bismuth (Bi), cobalt (Co); copper (Cu), iron (Fe), gallium (Ga), mercury (Hg), indium (In), manganese (Mn), nickel (Ni), lead (Pb), palladium (Pd), platinum (Pt), tin (Sn), and/or titanium (Ti)); a metal chalcogenide (e.g., As₂S, CuS, Cu₂S, Cu₂Se, NiS, Cu₂₋ₓSe, and/or Cu₂Te); a ternary chalcogenide (e.g., CuAlS₂, CuAlSe₂, CuAlTe₂, CuGaS₂; CuGaSe₂, CuGaTe₂, CuInS₂, CuInSe₂, CuInTe₂, CuSnS₂, CuSnSe₂, CuSnTe₂, and/or CuFeS₂); a quaternary chalcogenide (e.g., Cu₂ZnSnS₄), or any combination thereof. In certain embodiments, the particles include, consists essentially of; or consists of a metal. In some embodiments, the particles include Bi and/or In. The particles can have an absorption coefficient of 10⁻³ cm⁻¹ or more (e.g., 10⁻² cm⁻¹ or more, 10⁻¹ cm⁻¹ or more, 1 cm⁻¹ or more, 10 cm⁻¹ or more; 10² cm⁻¹ or more, 10³ cm⁻¹ or more, 10⁴ cm⁻¹ or more, 10⁵ cm⁻¹ or more; 10⁶ cm⁻¹ or more, 10⁷ cm⁻¹ or more, or 10⁸ cm⁻¹ or more) and/or 10⁹ cm⁻¹ or less (e.g., 10⁸ cm⁻¹ or less; 10⁷ cm⁻¹ or less; 10⁶ cm⁻¹ or less; 10⁵ cm⁻¹ or less; 10⁴ cm⁻¹ or less; 10³ cm⁻¹ or less, 10² cm⁻¹ or less, 10 cm⁻¹ or less, 1 cm⁻¹ or less, 10⁻¹ cm⁻¹ or less, or 10⁻² cm⁻¹ or less), at the incident electromagnetic radiation wavelength. For example, the particles can have an absorption coefficient of 10⁻² cm⁻¹ or more and 10⁹ cm⁻¹ or less (e.g., 10⁻¹ cm⁻¹ or more and 10⁸ cm⁻¹ or less, 10 cm⁻¹ or more and 10⁸ cm⁻¹ or less, 10³ cm⁻¹ or more and 10⁷ cm⁻¹ or less, or 10³ cm⁻¹ or more and 10⁶ cm⁻¹ or less).

When suspended in the fluid, the particle suspension can have a density of 10¹⁰ or more (e.g., 10¹¹ or more, 10¹² or more, 10¹³ or more, 10¹⁴ or more, 10¹⁵ or more, 10¹⁶ or more, or 10¹⁷ or more) and/or 10¹⁸ or less (e.g., 10¹⁷ or less, 10¹⁶ or less, 10¹⁵ or less, 10¹⁴ or less, 10¹³ or less, 10¹² or less, 10¹¹ or less) particles/cm³. Without wishing to be bound by theory, it is believed that the suspension should have a minimum particle density so that sufficient heating can occur at the particles to promote the formation of the nanostructures from the dissolved nanostructure precursors.

In some embodiments, when the suspension is irradiated with an electromagnetic radiation, such as a broad, collimated laser beam, the irradiated particles can melt fully or partially melt from a solid to a liquid, and growth of the nanostructure can start at the surface of the liquid surface of the irradiated particles. In some embodiments, the particles can melt due to diffusion of the nanostructure precursor into the particles, resulting in a liquid alloy droplet during nanostructure growth. In some embodiments, the irradiated particles are in liquid form during irradiation and growth of the nanostructure. In some embodiments, the irradiated particles are in solid form during irradiation and growth of the nanostructure.

In certain embodiments, when the suspension of particles in the fluid is irradiated, the particle, which transduce the electromagnetic radiation to heat, is heated preferentially compared to a surrounding fluid, and the temperature of the particle (e.g., at the surface, and/or throughout the particle) can be greater than the temperature of the bulk suspension. In certain embodiments, when the suspension of particles in the fluid is irradiated, the fluid volume around the particle, which transduces the electromagnetic radiation to heat, is higher than the average temperature of the bulk suspension. The temperature of the bulk solution can be measured, for example, by infrared thermometry, infrared thermography, or a thermocouple. The temperature of the particle can be calculated, for example, by using an analytical solution based on Mie theory or finite element solutions. In some embodiments, when the suspension is irradiated, the particles (e.g., at the surface, or throughout the particle) increases in temperature by 100° C. or more (e.g., 150° C. or more, 250° C. or more, 500° C. or more, 750° C. or more) and/or 1000° C. or less (e.g., 750° C. or less, 500° C. or less, 250° C. or less, or 150° C. or less). In some embodiments, when the suspension is irradiated, the temperature of the bulk suspension increases by 1200° C. or less (e.g., 1000° C. or less, 750° C. or less, 500° C. or less, or 250° C. or less) and/or 50° C. or more (e.g., 100° C. or more, 250° C. or more, 500° C. or more, 750° C. or more, or 1000° C. or more). In some embodiments, electromagnetic irradiation of the particle can provide a desired temperature at the particle surface in a relatively short time duration, such as at less than 1 second, less than 1 millisecond, less than one microsecond, or less than one nanosecond of electromagnetic irradiation. In some embodiments, the temperature at the surface of the particle can be controlled by varying the wavelength, duration, and/or temporal pattern of the electromagnetic irradiation.

The nanostructure precursor can be soluble in the fluid and can be dissolved in the fluid. In some embodiments, the nanostructure precursor can be any material that can decompose, assemble, and/or react when heated (e.g., heated above a decomposition or a reaction temperature to provide a nanostructure. For example, the nanostructure precursor can include an organometallic compound. (e.g., bis[bis(trimethylsilyl)amino]tin(II), bis(trimethylsilyl)[tris(trimethylsilyl)silyl]germane, bis[bis(trimethylsilyl)amino]tin(II), bis(N,N-diethyl-N′-naphthoylselenoureato)lead(II), cadmium oleate, dimethyl cadmium, cadmium stearate, cadmium diethyldithiocarbamate, cadmium n-octadecylphosphonate, cyclohexasilane, diethyl zinc, diphenylgermane, diphenylsilane, germanium 2,6-dibutylphenoxide, indium myristate, lead diethyldithiocarbamate, lead(II) imido(bis(selenodiisopropylphosphinate)), isotetrasilane, lead (II) octanoate, magic-sized clusters (as used herein, “magic-sized” refers to ultra-pure and highly stable groups of molecule-like precursors) as known to a person of skill in the art), magic-sized III-V clusters, monophenylgermane, monophenylsilane, neopentasilane, (PPh₃)₂Cu(μ-SePh)₂In(SePh)₂, tetrabutylgermane, tetraethylgermane, 1,1,2,2-tetrakis(trimethylsilyl)digermane, tetraphenylgermane, tetraphenylsilane, trichlorogermane, tri-n-butylphosphine selenide, tri-n-butylphosphine telluride, tri-n-octylphosphine selenide, tri-n-octylphosphine sulfide, tri-n-octylphosphine telluride, tri-tert-butylgallium, triethylgallium, triphenylgermane-triphenylsilane, trisilane, tris(trimethylsilyl)arsine, tris(trimethylsilyl)phosphine, {t-Bu₂In[μ-P(SiMe₃)₂]}₂, or zinc stearate; a metal salt (e.g., copper (I) acetate, copper (II) acetate, gallium (III) chloride, gallium (III) acetylacetonate, germanium (II) iodide, germanium (IV) iodide, indium (III) acetate, and/or indium (III) chloride); and a diamine-dithiol mixture (e.g., 1,2 and 1,2-ethylenediamine) including a dissolved bulk Group (V)₂-Group (VI)₃ chalcogenide (e.g., As₂S₃, As₂Se₃, As₂Te₃, Bi₂S₃, Bi₂Sₑ₃, Bi₂Te₃, Cu₂S, Cu₂Se, In₂S₃, Sb₂S₃, Sb₂Se₃, Sb₂Te₃, SnS, SnS₂, Sn₂S₃, Sn₃S₄, and/or Sn₄S₅; a carbon-containing precursor (e.g., toluene), or any combination thereof.

Once synthesized, the nanostructure can be an insulator, metal, or semiconductor. As used herein, an insulator has a high resistivity and does not freely conduct charge carriers. As used herein, a metal has a low resistivity and freely conducts charge carriers. As used herein, a semiconductor has a resistivity between that of a metal and an insulator. For example, the nanostructure can include Group IV elements (e.g., C, Si, Ge, and/or Ge₁₋ₓSnₓ); metal chalcogenides (e.g., Bi₂S₃, B₂iSe₃, Bi₂Te₃, CdS, CdSe, CdTe, CdSeₓS₁₋ₓ, CdZnS, CdZnTe, CuInS₂, CuInSe₂, Cu(InₓGa₁₋ₓ)Se₂, Cu₂ZnSnS₄, PbS, PbSe, PbTe, PbSeₓS₁₋ₓ, PbSnTe, SnS, SnS₂, SnTe, ZnS, ZnSe, ZnTe, ZnSeₓTe₁₋ₓ, and/or GeTe); metal pnictides (e.g., CuₓSb, GaAs, GaN, GaP, GaSb, InAs, InN, InP, and/or InSb), or any combination thereof.

In some embodiments, any fluid that dissolves the nanostructure precursors and provides a stable medium for the particles and the resulting nanostructures can be used. For example, the fluid can include an organic solvent, a mixture of organic solvents, or a mixture of an organic solvent and water. Such a fluid can be suitable, for example, for an organic solvent-soluble nanostructure precursor. When the solvent is a mixture, the mixture can be homogeneous, or multiphasic. The nanostructure precursors can be soluble in one or more phases when the solvent is multiphasic. In some embodiments, the growth of the nanostructure can occur at an interface of a multiphasic solvent mixture, for example, when the nanostructure precursor is present in one phase of the solvent mixture. In some embodiments, the solvent mixture is miscible and homogenous. When the water is part of a mixture with one or more organic solvents, the water can be present in an amount of 1% or more (e.g., 5% or more, 10% or more, 15% or more, 20% or more, or 25% or more) and/or 30% or less (e.g., 25% or less, 20% or less, 15% or less, 10% or less, or 5% or less) by volume in a solvent mixture. In some embodiments, the solvent mixture can include a surfactant and/or a ligand.

In some embodiments, the organic solvent can include benzene, hexanes, isobutylamine, 1-octadecene, oleylamine, squalene, squalene, toluene, trioctylamine, trioctylphosphine, trioctylphosphine oxide, 1,2-ethanedithiol and 1,2-ethylenediamine, a hydrocarbon (e.g., hexane, heptane, octane, hexene, octene, and/or decene), isomers thereof, or any combination thereof. In some embodiments, the organic solvent has a boiling point of 30° C. or greater.

In some embodiments, the fluid is aqueous. The fluid can be used to dissolve water-soluble nanostructure precursors. The aqueous fluid can include a relatively large proportion of water. For example, the fluid can contain more than 30% by volume (e.g., 40% or more, 60% or more, 80% or more, 90% or more, or 95% or more) and/or 100% or less 95% or less, 90% or less, 80% or less, 60% or less, or 40% or less) by volume of water in am aqueous solvent mixture. The aqueous fluid can include a buffering agent, a surfactant, and/or a ligand.

In some embodiments, the fluid is gaseous. Examples of gaseous fluid include nitrogen gas, argon gas, oxygen gas, chlorine gas, hydrogen gas, and any combination thereof.

The nanostructure precursor is soluble in the fluid at room temperature (e.g., 21° C.), or at a higher temperature (e.g., up to and including the reaction temperature). For example, the nanostructure precursor can be soluble in a liquid at a temperature of 20° C. or more (e.g., 30° C. or more, 50° C. or more, 100° C. or more, 200° C. or more, 300° C. or more, or 400° C. or more) and/or 500° C. or less (e.g., 400° C. or less, 300° C. or less, 200° C. or less, 100° C. or less, 50° C. or less, or 30° C. or less). The nanostructure can be soluble in a gas at a temperature of 20° C. or more (e.g., 30° C. or more, 50° C. or more, 100° C. or more, 200° C. or more, 300° C. or more. 400° C. or more, 500° C. or more, 600° C. or more, 700° C. or more, 800° C. or more, 900° C. or more, 1000° C. or more, or 1100° C. or more) and/or 1200° C. or less (e.g., 1100° C. or less, 1000° C. or less, 900° C. or less, 800° C. or less, 700° C. or less, 600° C. or less, 500° C. or less, 400° C. or less, 300° C. or less, 200° C. or less, 100° C. or less, 50° C. or less, or 30° C. or less). The nanostructure precursor can be present in the fluid at a concentration sufficient to provide the nanostructure. For example, the nanostructure precursor can be in the fluid at a concentration of greater than 0% and/or 30% or less. In some embodiments, the nanostructure precursor can be the fluid itself and be present at a concentration of 100%.

In some embodiments, a dopant precursor can be added at any time to the fluid and the suspension including the plurality of particles and/or the nanostructure precursor, upon irradiating the at least one particle with an incident electromagnetic radiation having a wavelength of from 300 nm to 15,000 nm, a doped nanostructure can be provided. The resulting doped nanostructure can be intermittently doped, or doped at select locations to provide a heterostructured non-homogeneous nanostructure. In some embodiments, the dopant precursor can be any compound capable of delivering a dopant to be incorporated into the growing nanostructure. For example, the dopant precursor can include an organic compound, an organometallic compound, a metal salt, a salt, a diamine-dithiol mixture (e.g., 1,2-ethanedithiol and 1,2-ethylenediamine) including a dissolved bulk Group (V)₂-Group (VI)₃ chalcogenide, or any combination thereof. The dopant can include aluminum (Al), arsenic (As), gold (Au), boron (B), beryllium (Be), bismuth (Bi), carbon (C), cadmium (Cd), chlorine (CI), cobalt (Co), chromium (Cr), copper (Cu), fluorine (F), iron (Fe), gallium (Ga), germanium (Ge), iodine (I), indium (In), magnesium (Mg), manganese (Mn), nitrogen (N), sodium (Na), nickel (Ni), phosphorus (P), lead (Pb), platinum (Pt), rhenium (Re), sulfur (S), antimony (Sb), selenium (Se), silicon (Si), tin (Sn), tellurium (Te), tantalum (Tl), vanadium (V), zinc (Zn), and/or lanthanides (e.g., lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tin), ytterbium (Yb), and/or lutetium (Lu)). The dopant can be present in the nanostructure in an amount of more than 0% (e.g., 5% or more, 10% or more, 15% or more, 20% or more, 25% or more) and/or 30% or less (e.g., 25% or less, 20% or less, 15% or less, 10% or less, or 5% or less) by mass.

The incident electromagnetic radiation can have a variable wavelength. For example, the wavelength of the incident electromagnetic radiation can vary during a nanostructure synthesis, for example, as a function of a given precursor in the fluid. The electromagnetic radiation can be pulsed, or continuous. In some embodiments, the incident electromagnetic radiation has a wavelength of 300 nm or more (e.g., 450 nm or more, 600 nm or more, 800 nm or more, 1,000 nm more, 2,500 nm or more, 5,000 nm or more, 7,500 nm or more, 10,000 nm or more, or 12,500 nm or more) and/or 15,000 nm or less (e.g., 12,500 nm or less, 10,000 nm or less, 7,500 nm or less, 5,000 nm or less, 2,500 nm or less, 1,000 nm or less, 800 nm or less, 600 nm or less, or 450 nm or less). In certain embodiments, the incident electromagnetic radiation has a wavelength of 300 nm or more and 1200 nm or less (e.g., 300 nm or more and 1100 nm or less, 450 nm or more and 1100 nm or less, 600 nm or more and 1100 nm or less, 800 nm or more and 1100 nm or less, 1000 nm or more and 1100 nm or less, or 1070 nm). In some embodiments, the radiation is a broadband radiation. In some embodiments, the radiation includes multiple separate wavelengths. In certain embodiments, the radiation is polarized. In certain embodiments, the radiation is unpolarized. For example, the radiation can be linearly polarized. As another example, the radiation can be circularly polarized.

The nanostructure synthesis methods of the present disclosure can be carried out at atmospheric pressure. When a component of the reaction mixture is oxygen-sensitive (e.g., reactive with oxygen), the reaction can be carried out in an oxygen-free environment. In some embodiments, when the reaction is not oxygen-sensitive, the nanostructure can be grown or assembled in an atmosphere that contains oxygen, for example, at ambient conditions (e.g., at room temperature of about 21° C., atmospheric pressure, and ambient atmosphere). The nanostructure is grown in a free-flowing solution, without the need to affix a particle seed or a growing nanostructure to a substrate, and without the use of high-pressure reactors or deposition chambers.

In some embodiments, the nanostructure is characterized in situ through scattering and spectroscopic measurements (e.g., photoluminescence spectroscopy, absorption spectroscopy, and/or X-ray spectroscopy), which can allow for high-throughput screening of the nanostructures.

The reactor for carrying out the synthesis is not limited, so long as it can stably contain the fluid suspension and has a window that is optically transparent to the incident electromagnetic radiation. For example, the reactor can be a quartz container, such as a quartz cuvette. The reaction mixture in the reactor can be optionally shaken, agitated, stirred, or otherwise mixed during the reaction process, for example, using a stir bar, a sonicator, a shaker, and the like.

In some embodiments, rather than providing a static amount of a reaction mixture (e including a fluid, particles suspended in the fluid, and/or the nanostructure precursor) in a reactor, a reaction mixture can be continuously flowed through a reactor, and the electromagnetic irradiation can be directed to a predetermined location (e.g., an optically transparent window) in the reactor. The reactor for such a reaction can be a flow-through reactor, such as a fluidic reactor having an optically transparent area that allows an incident electromagnetic radiation to irradiate the particles suspended in the fluid. The suspension of particles, dissolved nanostructure precursors, and fluid can continuously flow through the flow-through reactor, and at least one particle can be irradiated with the incident electromagnetic radiation at a predetermined location in the reactor so that the particles absorb the incident electromagnetic radiation and transduce the electromagnetic radiation to localized heat, which in turn allows the soluble nanostructure precursor to react to grow a nanostructure from a surface of the irradiated particles. The flow-through reactor can have an inlet and an outlet, where the inlet can be used to introduce particles, nanostructure precursors, and/or the fluid; and the outlet can be used to collect the synthesized nanostructures. The reactor can optionally include a mechanism for flowing the reaction mixture through the reactor, such as a pump (e.g., a syringe pump), gravity, and/or capillary forces, and can be coupled to a control device, such as a computer.

A nanostructure synthesized according to the methods of the present disclosure can have an elongated form, such as a nanotube or a nanowire. As used herein, a nanotube is a hollow tubular structure, while a nanowire is a solid elongated structure. The nanostructure can have an aspect ratio of from 2:1 (e.g., from 10:1, from 50:1, from 100:1, from 1,000:1, from 5,000:1, from 10,000:1, or from 50,000 to 1) to 100,000:1 (e.g., to 50,000:1, to 10,000:1, to 5,000:1, to 1,000:1, to 100:1, to 50:1, or to 10:1). In some embodiments, the nanostructure can have a diameter of 2 nm or more (e.g., 5 nm or more, 10 nm or more, 50 nm or more, 100 nm or more, 200 nm or more, 300 nm or more, or 400 nm or more) and/or 500 nm or less (e.g. 400 nm or less, 300 nm or less, 200 nm or less, 100 nm or less, 50 nm or less, 10 nm or less, or 5 nm or less). In certain embodiments, the nanostructure can have a length of 10 nm or more (e.g.; 50 nm or more, 100 nm or more, 500 nm or more, 1 μm or more, 25 μm or more, 50 μm or more, or 75 μm or more) and/or 100 μm or less (e.g., 75 μm or less, 50 μm or less, 25 μm or less, 1 μm or less, 500 nm or less, 100 nm or less, or 50 nm or less).

The following examples are included for the purpose of illustrating, not limiting, the described embodiments. Example 1 below describes a solution-based process; and a continuous solution-based nanowire growth process, for bismuth-seeded germanium nanowires, bismuth-seeded cadmium selenide nanowires, and indium-seeded germanium nanowires.

### EXAMPLES

### Example 1, Radiation-Assisted Synthesis of Nanostructures

This Example describes a continuous, solution-based nanowire growth process that exploits the high absorption coefficient of metal nanocrystals to photothermally drive semiconductor nanowire growth. In this process, an incident electromagnetic radiation (e.g., a laser) irradiates a solution containing metal nanocrystals and semiconductor precursors. Upon light absorption, the metal nanocrystals rapidly heat, inducing local semiconductor precursor decomposition and the growth of crystalline nanowires. This process was performed on a benchtop in simple glassware under standard conditions. To demonstrate the generality of this technique, semiconductor nanowires were synthesized using three distinct material systems: bismuth-seeded germanium nanowires, bismuth-seeded cadmium selenide nanowires, and indium-seeded germanium nanowires.

For both vapor- and solution-based nanowire growth, past work has exclusively focused on irradiating a fixed substrate that has been decorated with metal nanocrystals. This substrate-based configuration lacks scalability, which is advantageous for solution-phase nanowire growth. Actualizing light-driven, substrate-free, solution-based nanowire growth can access a broad range of nanowire chemistries that require higher temperatures as well as continuous flow-based nanowire growth on the benchtop without the need for expensive or niche equipment.

Here the unique optical properties of metallic nanomaterials under laser irradiation to act as both a thermal energy source and as a growth-directing seed are used to grow anisotropic semiconductor nanostructures through a bottom-up, one-step, colloidal, solution-based process. By using metal nanocrystals to transduce incident irradiation into thermal energy, rather than globally heating the reaction solvent, reactor design constraints are lifted to provide the growth of semiconductor nanowires on the benchtop, eliminating the need for specialized, high-temperature or high-pressure equipment. By using a dispersion of nanocrystals, rather than a metal nanocrystal-decorated substrate, a system is presented in which colloidal nanocrystals irradiated with a broad beam can reach the high temperatures (>200° C.) required for solution-phase nanowire synthesis. This demonstrates a generalizable process for semiconductor nanowire growth that can be performed on a benchtop in either batch or continuous operation, for rapid, high-throughput screening and parameter optimization during nanowire growth.

Bismuth (III) chloride (BiCl₃ 99.99% trace metals basis), cadmium oxide (CdO, ≥99.9% trace metals basis), ethanol (anhydrous, ≤0.005% water), indium (III) chloride (99.999% trace metals basis), isopropanol (anhydrous, 99.5%), molecular sieves (3 Å), n-butyllithium (1.3 M in n-heptane), 1-octadecene (ODE, 90%), oleylamine (90%), oleic acid (degassed, 90%), sodium bis(trimethylsilyl)amide (1.0 M solution in tetrahydrofuran), squalane (96%), Super-Hydride® solution (1.0 M lithium triethylborohydride in tetrahydrofuran), selenium (Se, <5 mm particle size, ≥0.99.999% trace metals basis), tetrahydrofuran (THF, anhydrous, ≥99.9%), toluene (anhydrous, 99.8%), and trioctylphosphine (TOP, 97%) were purchased from Sigma-Aldrich. Diphenylgermane (>95%) was purchased from Gelest. Poly(1-hexadecene-co-1-vinylpyrrolidinone) (PEED-co-PVP) was provided by Ashland under the trade name Ganex™ V-216. Toluene (Certified ACS, 99.8%) was purchased from Fisher. Ethanol (200 proof) was purchased from Decon Laboratories.

Bismuth Nanocrystal Synthesis

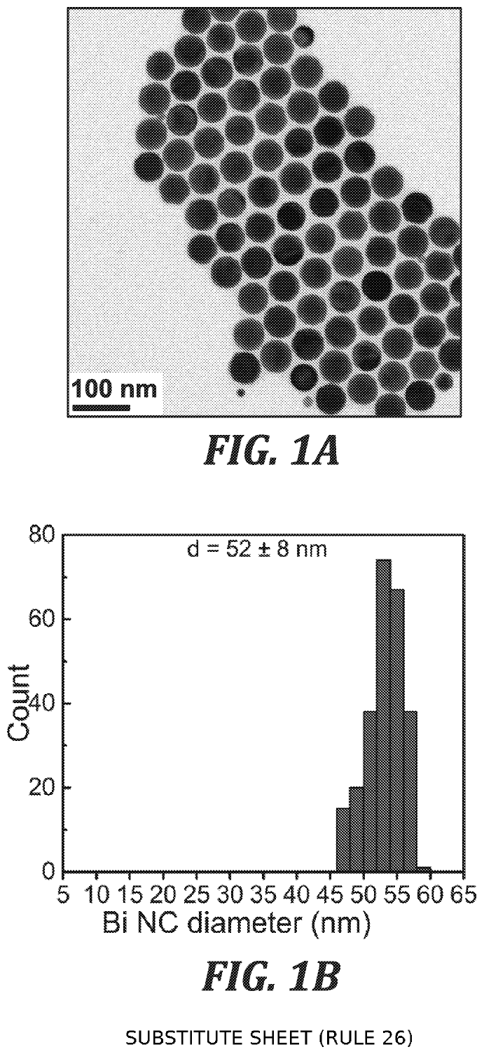

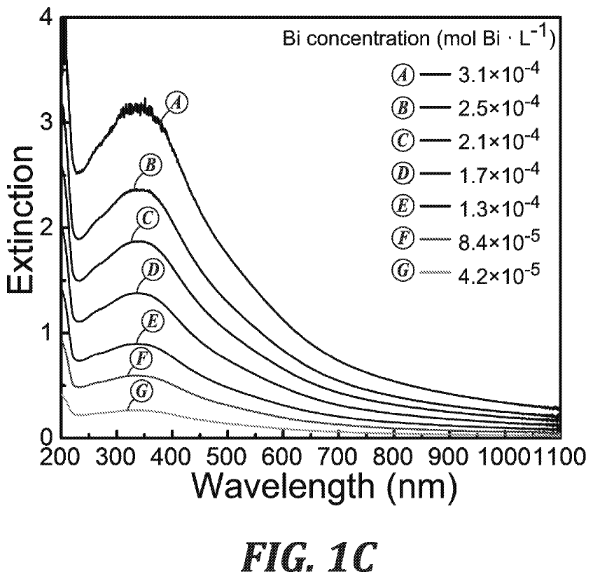

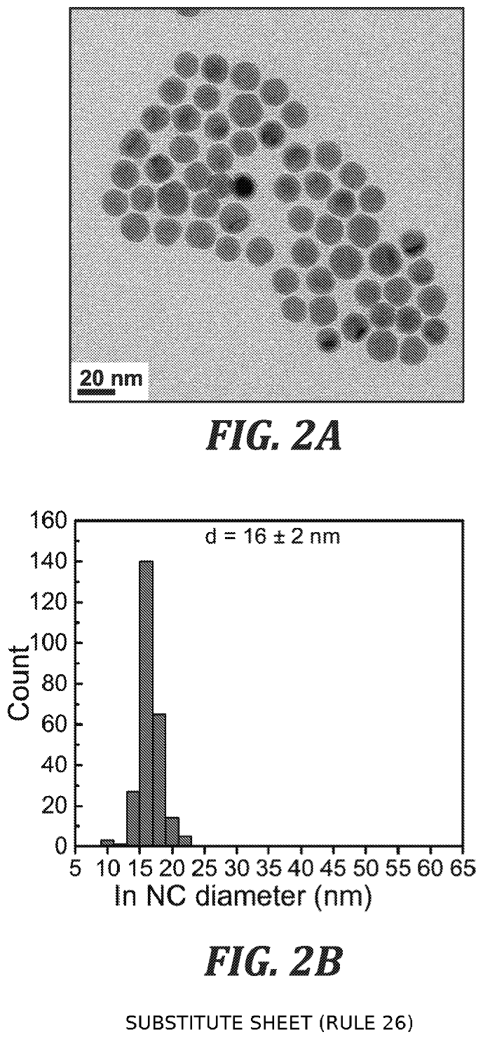

Bismuth nanocrystals were synthesized based on a previously described protocol. In brief a 25 wt % solution of PHD-co-PVP in 1-octadecene was dried over molecular sieves for one week. BiCl₃ (2.6×10⁻² mmol) was mixed at 800 RPM with THF (570 μL) under nitrogen for thirty minutes. The solution of PM-co-PAT in octadecene (6.1 mL) was added to the flask under continuous mixing at 900 RPM. The flask was cycled between nitrogen and vacuum three times. Sodium bis(trimethylsilyl)amide (825 μL) was injected and the reaction mixture stirred until a dark orange-brown color was observed (˜10 minutes, 1100 RPM). The solution was then heated to 200° C. for 17 hours, cooled, and then transferred into the glove box for storage. Bismuth nanocrystals were handled under nitrogen for the washing steps. NCs were washed with a 1:4 ratio of anhydrous hexanes:ethanol three times and centrifugated (6800 RCF for 10 minutes) to remove excess PHD-co-PVP prior to use for NW growth. The average size of bismuth nanocrystal seeds was 52 nm 8 nm. FIGS. 1A-1C shows the TEM image, size distribution, and extinction spectra of the bismuth nanocrystals, respectively.

Indium Nanocrystal Synthesis

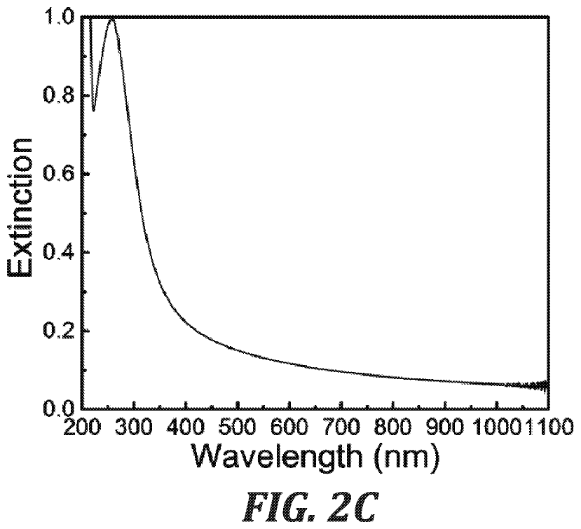

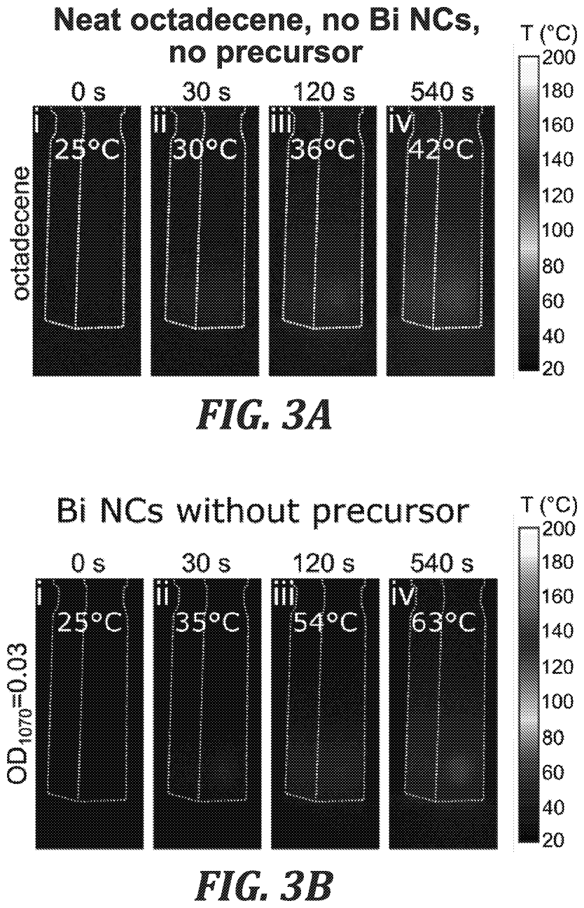

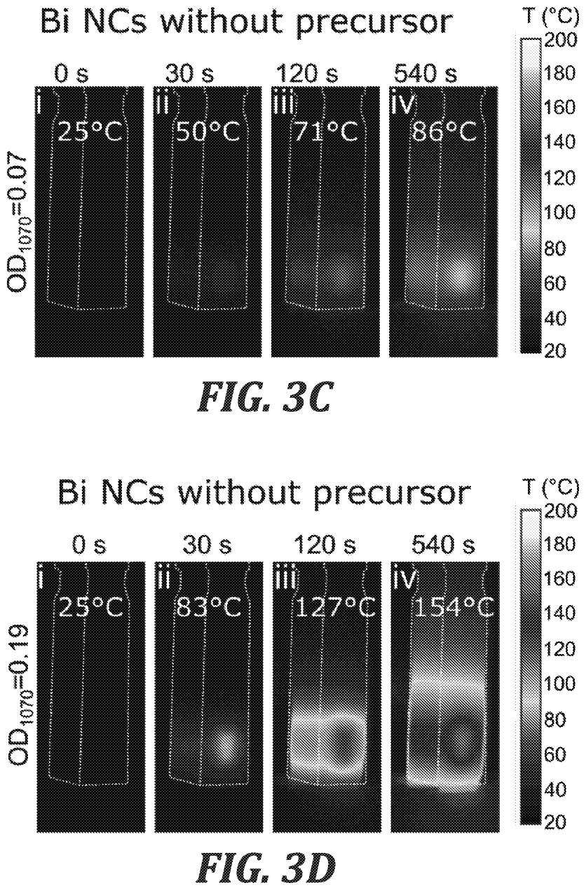

Indium nanocrystals were synthesized as previously described. IN brief, InCl₃ (1.4×10⁻¹ mmol) was measured in the glove box, transferred into a three-neck flask, and transferred to the Schlenk line. The flask was purged with nitrogen. The flask was transferred between vacuum and nitrogen three times. Oleylamine (13 mL) was added to the flask, which was heated to 100° C. under mixing (1000 RPM) and was placed under vacuum further for 45 minutes. The mixture was blanketed with nitrogen and increased to 160° C. The n-butyllithium solution (1.3 mL) was injected into the flask, followed by an injection of the superhydride solution (300 μL). The reaction was allowed to run for ten seconds, whereupon 12 mL of anhydrous toluene was injected to quench the reaction and cool the solution. At 50° C., oleic acid (400 μL was added to stabilize the nanocrystals, NCs were transferred into a glove box and handled under nitrogen for the washing steps. Anhydrous ethanol (12 mL) was added to the dispersion and the dispersion was centrifuged at 4180 RCF 10 minutes. The supernatant was discarded, and the nanocrystals were washed with a 2:1 ratio of anhydrous hexanes:ethanol three more times. The average size of indium nanocrystal seeds was 16 nm±2 nm. FIGS. 2A-2C shows the TEM image, size distribution, and extinction spectra of the indium nanocrystals, respectively.

Cadmium Oleate Synthesis

Using typical Schlenk line techniques, 0.15 M cadmium oleate (CdO) in 1-octadecene (ODE) was prepared by combining 210 mg CdO, 2.7 g oleic acid and 5.2 g ODE in a flask. The mixture was blanketed with nitrogen and stirred at 800 RPM, heated to 110° C., and placed under vacuum for 30 minutes. The mixture was cooled to room temperature under nitrogen and transferred to a glove box, whereupon 1 mL of trioctylphosphine (TOP) was added and mixed for 15 minutes.

Trioctylphospine-Selenide (TOP:Se) Synthesis

A 1.0 M stock solution of TOP:Se was prepared in the glove box by stirring mg of Se in 5 mL TOP overnight to dissolve.

Nanowire Growth Solutions for Photothermal Nanowire Growth

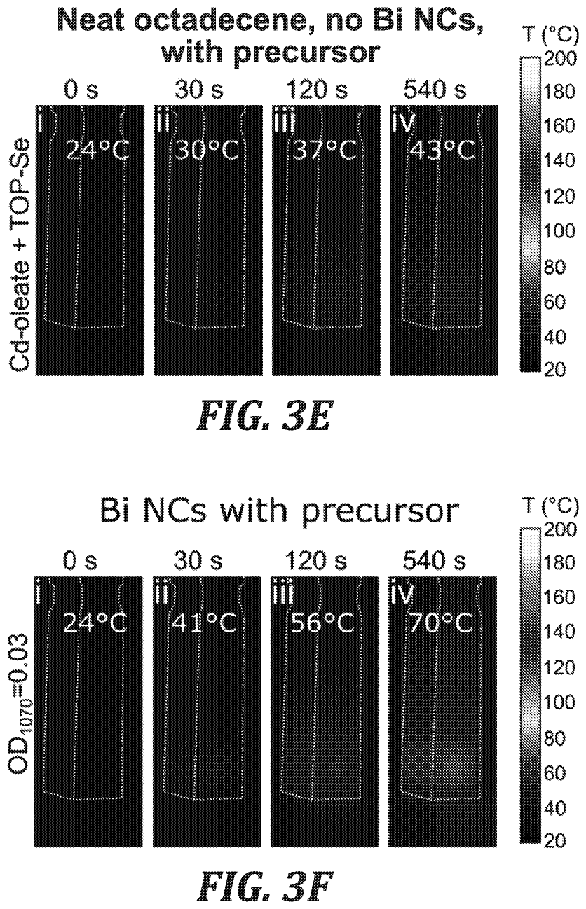

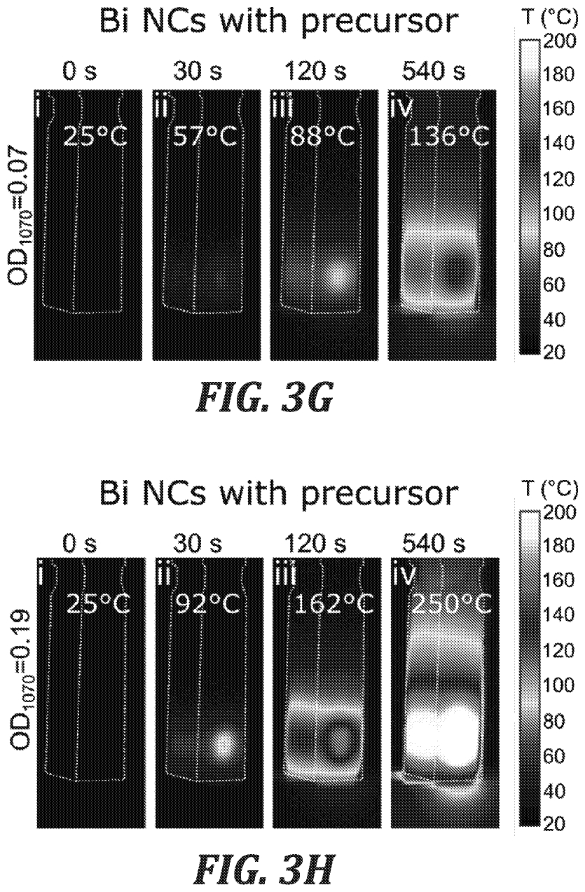

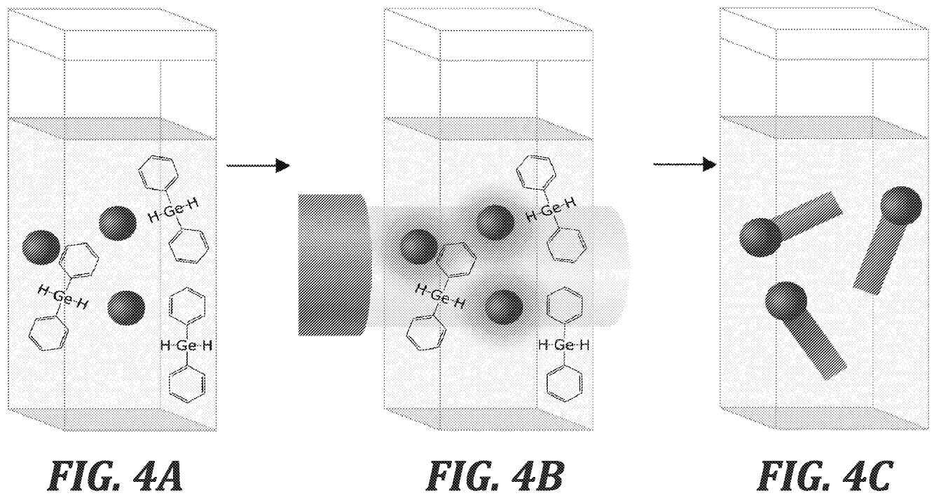

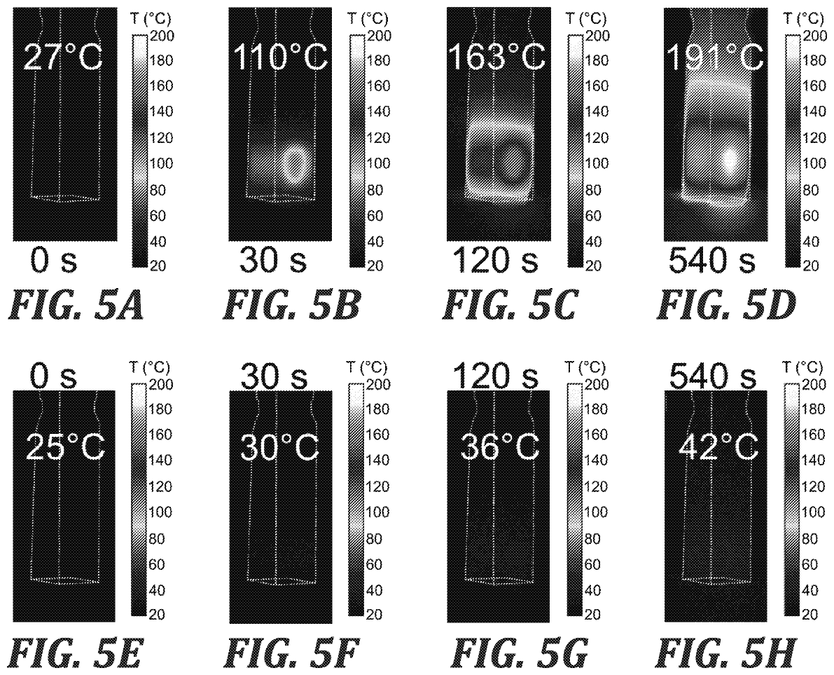

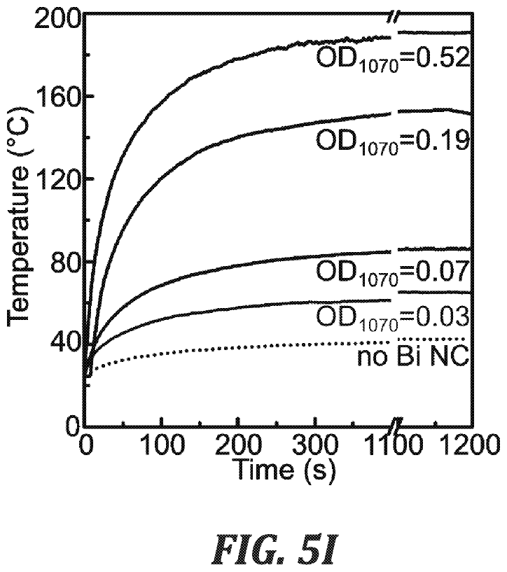

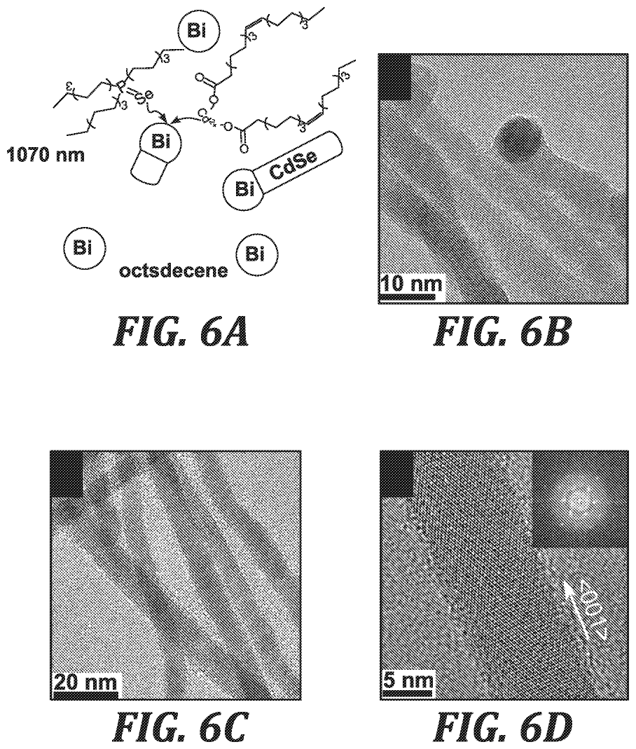

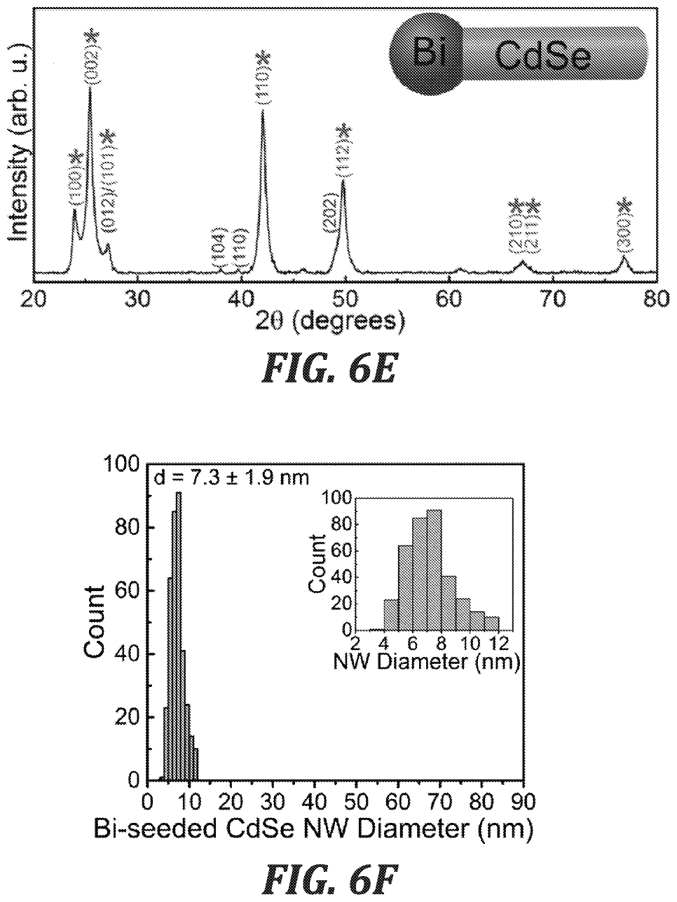

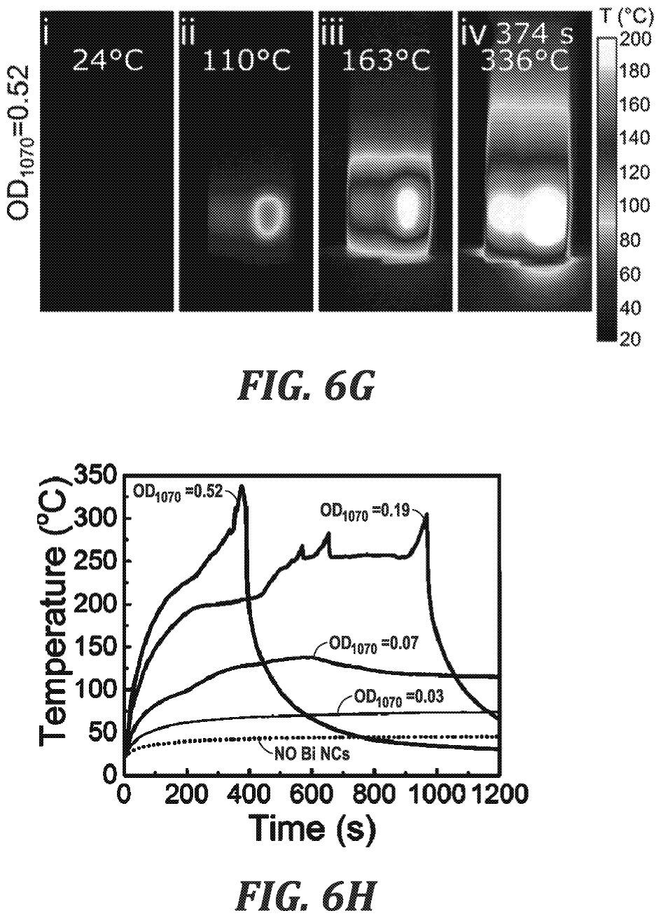

All nanowire precursor growth solutions were prepared and mixed under a nitrogen atmosphere in a quartz cuvette, which was lined with a thin layer of Teflon tape prior to screwing the cap on. The cap was wrapped with Parafilm to further prevent oxidation of the nanocrystals. FIGS. 3A-3D shows the thermal infrared images of bismuth nanocrystal suspensions having different nanocrystal concentrations under irradiation (1070 nm, 15 W). FIGS. 3E-3H shows the nanowire growth suspensions with bismuth nanocrystal suspensions having different nanocrystal concentrations under irradiation (1070 nm, 15 W), showing the evolution of the temperature profile in the cuvette.

Bi-Seeded Cadmium Selenide Nanowire Growth Solution

The Bi-seeded CdSe nanowire precursor growth solution was prepared under a nitrogen atmosphere in a quartz cuvette. 50 μL of a Bi NC dispersion (1.34 mg atomic Bi/L) in hexane, 125 μL Cd-oleate (0.15 M in 1-ODE), and 213 μL TOP:Se were combined and mixed in a screw-top quartz cuvette.

Bi-Seeded Germanium Nanowire Growth Solution

The Bi-seeded Ge nanowire precursor growth solution was prepared under a nitrogen atmosphere in a quartz cuvette. 50 μL of a Bi NC dispersion (1.34 mg atomic Bi/L) in hexane, 100 μL diphenylgermane (DPG), and 150 μL squalane were combined and mixed in a screw-top quartz cuvette.

In-Seeded Germanium Nanowire Growth Solution

The Bi-seeded Ge nanowire precursor growth solution was prepared under a nitrogen atmosphere in a quartz cuvette. 50 μL of an In NC dispersion in hexane, 100 μL diphenylgermane (DPG), and 150 μL squalane were combined and mixed in a screw-top quartz cuvette.

Photothermal Nanowire Growth

Nanowire precursor growth solutions that include metal nanocrystals, molecular semiconductor precursors, and squalane or ODE, were loaded into a screw-top quartz cuvette in the glove box, where the top of the cuvette was lined with Teflon and then wrapped with Parafilm to prevent oxidation of nanocrystals. The cuvette with the growth solution was transferred out of the glove box and subsequently irradiated with a high-power, polarized near-infrared fiber laser (λ=1070 nm) at a range of powers (15-20 W) and times (5-20 minutes). The solvent boiled more rapidly when higher powers were used to irradiate the cuvette-based synthesis, resulting in shorter reaction times for samples that were irradiated with high powers. The resulting product was washed with a 2:1 ratio of toluene and ethanol, collected by centrifugation at 19000 RCF, dispersed in toluene, and washed two more times.

Transmission electron microscope (TEM) images were acquired with a FEI Technai G2 F20 Supertwin TEM at a 200 kV accelerating voltage and were analyzed with linage) Software. X-ray Diffraction scans were collected with a Bruker D8 Discover with IμS 2-D XRD system and were analyzed using EVA software. Inductively Coupled Plasma-Optical Emission Spectroscopy (ICP-OES) was performed with a Perkin Elmer Optima 8300 Spectrophotometer. UV-vis extinction spectra were collected with an Agilent Cary 60 UV-vis spectrophotometer. Time-dependent infrared thermal imaging was performed with a FLIR A325sc camera using the 0-350° C. temperature range setting, and the resulting videos were analyzed using ResearchIR software.

The contact free, laser-driven, solution-based nanowire growth process is detailed in FIGS. 4A-4C, in which a cuvette contains a dispersion of metal nanocrystals and molecular precursors (FIG. 4A) for semiconductor nanowire growth. Upon irradiation (FIG. 4B), the nanocrystals generate heat to decompose the molecular semiconductor precursors, which enables semiconductor atoms to diffuse into and alloy with the metal nanocrystal, thereby facilitating nanowire growth (FIG. 4C). In order to realize this method of nanowire growth, the colloidal metal nanocrystals must be able to generate heat upon irradiation.

To examine the potential heating effects generated by contact-free irradiation of low-melting point metal nanocrystals in dispersion, bismuth nanocrystals were irradiated at a range of concentrations, dictated by the optical density of the dispersion at the excitation wavelength of the 1070 nm laser. Infrared images of bismuth nanocrystals dispersed in ODE (OD₁₀₇₀=0.52) under irradiation (FIGS. 5A-5D) demonstrate the rapid heating achieved by optical irradiation, particularly when contrasted to irradiation of ODE in the absence of bismuth nanocrystals (FIGS. 5E-5H). Without wishing to be bound by theory, it is believed that the nanoparticles heat the solvent, which in turn heats the quartz cuvette walls. The cuvette surface emits far-infrared light, which is used in thermography to measure the temperature of the cuvette surface. Thus, the reaction volume is likely at a higher temperature due to heat transfer resistances through the solvent volume and quartz cuvette walls. As the optical density of the Bi nanocrystal dispersion increases, the maximum temperature achieved in the bulk solvent also increases (FIG. 5f). Although there is a relatively small temperature increase (17° C.) of the neat solvent in the absence of nanocrystals under irradiation, the rapid increase in temperature of the Bi nanocrystal dispersions is clearly due to the generation of heat from the irradiated metal nanocrystals. Because these colloidal bismuth nanocrystals are dispersed in solution, rather than pinned to a substrate, they have the potential to reach very high temperatures due to the large Young-Laplace interfacial surface pressure required to nucleate a bubble. By utilizing metal nanocrystal light absorption to drive the reaction, the immediate environment near the nanocrystal surface likely reaches higher temperatures than the bulk solvent. Using metal nanocrystals to transduce light to thermal energy lifts the temperature and gas handling requirements of the reactor to a certain extent, thus allowing the use of a simple quartz cuvette on a benchtop as a reaction vessel.

In addition to measuring the temperature dependence on bismuth nanocrystal concentration through infrared thermography, COMSOL was used to model the surface temperature of an irradiated cuvette, containing a bismuth nanocrystal dispersion. These numerical solutions accurately calculate the surface temperature of the cuvette at low bismuth nanocrystal concentrations. However, the calculated temperatures diverge from experimentally measured values at higher nanocrystal concentrations and higher temperatures. Inaccurate numerical solutions at higher bismuth nanocrystal concentrations suggest that the model likely fails to account for high temperature effects, such as solvent boiling, Ostwald ripening, or coalescence of bismuth nanocrystals, which are not included in the model. With this caveat, the numerical model provides an upper bound of internal temperatures and demonstrates that the nanocrystals in the center of the cuvette reach up to 800° C. at steady state. Using an analytical solution based on a Mie theory source term, the temperatures of single bismuth or indium nanocrystals suspended in an infinite bath of the growth solution were calculated. Under illumination in this formalism, bismuth and indium nanocrystals heat very little relative to the temperature of the overall growth solution, indicating that, at these laser irradiances and absorption coefficients, a single nanocrystal may not sufficiently heat to drive nanowire growth. Without wishing to be bound by theory, this observation suggests that the nanocrystals heat via collective absorption and subsequent heat diffusion. Thus, the achievable temperature and the successful synthesis of nanowires can depend on both concentration of nanocrystals and the irradiance.

With clear evidence of heat generation from the unfocused irradiation of a metal nanocrystal dispersion, II-VI molecular precursors were incorporated to make a nanowire growth solution (e.g., a solution-liquid-solid (SLS) solution). Under irradiation, the nanowire growth solution in the presence of the bismuth nanocrystals heated rapidly. Infrared thermal images and associated temperature profiles show that nanowire growth solution temperatures under irradiation similarly increase with an increased concentration of bismuth nanocrystals.

The high temperatures reached during laser irradiation of bismuth nanocrystals facilitated the decomposition of CdSe molecular precursors and seeded nanowire growth in solution on the benchtop (FIG. 6A-6E). For SLS-based nanowire growth, seeded growth of CdSe nanowires typically requires temperatures in the range of 230-350° C.; here, the heat generated from the nanocrystals from the contact-free, photothermal reaction enabled high reaction temperatures in a quartz cuvette on a benchtop. Although the temperatures from the infrared thermal imaging camera were representative of the bulk solvent temperature, the temperature at the nanocrystal-solvent interface is likely higher than the bulk solvent. This is emphasized by the nanowire growth solution with an OD₁₀₇₀=0.07, which reached a maximum bulk solvent temperature of 1.36° C., but still was able to grow CdSe nanowires. For all of the experiments, after blocking the laser, the resulting nanowire product rapidly flocculated, BF-TEM (FIG. 6B-6D) images clearly demonstrate that laser heating did not result in homogeneous nucleation of the CdSe precursors upon decomposition. Rather, the bismuth seed acted as a growth-directing agent to produce CdSe NWs via a photothermally-driven SLS mechanism. Compared to previous optically-driven growth of II-IV NWs that required a two-step synthesis, the synthesis of CdSe NWs here was performed in one step. TEM (FIG. 6B-6D) highlights the narrow diameters, 7.3±1.9 nm, achieved from this photothermally-driven process. HR-TEM (FIG. 6D) shows that the CdSe NWs have a <001> growth direction and is consistent with XRD, which shows an increased intensity of the (002) peak due to the nanowire anisotropy (FIG. 6E). FIG. 6F shows the distribution of Bi-seeded CdSe nanowires diameters synthesized by laser-driven growth. FIG. 6G shows the thermal infrared time series images of a nanowire precursor solution with bismuth nanocrystals at high concentrations (OD₁₀₇₀=0.52) under irradiation (1070 nm, 15 W), demonstrating the high temperatures achieved by photothermal heating and FIG. 6H shows the time-dependent temperature profiles for different bismuth nanocrystal concentrations (OD₁₀₇₀=0.03-0.52) with CdSe precursors under irradiation (1070 nm, 15 W).

Semiconductor nanowires produced via metal-seeded, solution-based growth have been fabricated over a wide range of ionicity and covalency. Generally, the synthesis of more ionic nanowires, such as CdSe, require relatively low temperatures; however, higher temperatures (>300° C.) are often required to synthesize more covalent nanowires, such as Si or Ge. In order to investigate the potential scope of photothermally-driven nanowire growth, a more covalent nanowire system, Ge, that requires higher reaction temperatures, was studied.

Using the same bismuth nanocrystal seeds to drive the reaction, the versatility of this laser-driven, colloidal-based synthesis was demonstrated by also producing, group IV semiconductor NWs. Similarly, the bismuth nanocrystals under irradiation act as both the local heat sources and as the seed for germanium nanowire growth; the diphenylgermane precursor decomposed and alloyed directly with the bismuth seeds to facilitate optically-driven SLS Ge NW growth (FIGS. 7A-7E). BF-TEM images (FIG. 7B-7D) demonstrate the growth of crystalline Ge NWs with 15.6±7.8 nm diameters and a <111> growth direction. XRD (FIG. 7E) clearly shows the presence of both crystalline Bi and Ge. The Bi-seeded Ge NWs synthesized through contact-free photothermal heating typically have a tortuous morphology, likely due to rapid changes in temperature in the cuvette as convection patterns form due to the small volume of solution irradiated and heated in the cuvette. Both material examples above—Bi-seeded CdSe and Bi-seeded Ge NWs—use Bi nanocrystals as local heat sources and as nanowire growth-directing agents. In order to further the scope of this study, additional material systems were studied that could be used to generate heat and facilitate wire growth under laser irradiation. FIG. 7F shows the distribution of Bi-seeded germanium nanowire diameters synthesized by laser-driven growth.

Indium (In) nanoparticles have been used to grow germanium nanowires through VLS growth and other semiconductor nanowires through modified SLS growth. Most work that has used In seeds for nanowire growth exploited the low melting point of indium to generate In seeds from an evaporated thin film of In on a substrate. Here, the use of colloidal In nanocrystals as local heat sources under irradiation to decompose diphenylgermane and to enable anisotropic growth of germanium nanowires in solution was demonstrated (FIG. 8A-8E). The In-seeded Ge nanowires generated from this optically-driven process generally had shorter lengths and wider diameters when compared to the photothermally-grown Bi—CdSe and Bi—Ge systems. These morphological differences could be attributed to the markedly lower melting point of In (156° C.) when compared to Bi (271° C.), which could result in more rapid coalescence of in nanoparticles upon irradiation and heat generation, leading to larger seed particles and thus, larger nanowire diameters. FIG. 8F shows the distribution of In-seeded germanium nanowire diameters synthesized by laser-driven growth.

Notably, this process generated SLS NWs without the use of a Schlenk line, insulation, or resistive heating at “bulk” ambient temperatures due to photothermal heating. In comparison, bulk, resistively-heated. SLS NW growth involves an isothermal process in which the reaction vessel and chemical are at thermal equilibrium. The high temperatures generated by contact-free, optical heating of the metal nanocrystals can rapidly drive nanowire growth without the need for high temperature equipment. In addition to using a quartz cuvette as a reaction vessel, a simple NMR tube was also used. Moreover, an 808 nm diode at a much lower power (2 W) was used as an excitation source to grow Bi-seeded CdSe nanowires (demonstrating that high-powers are not necessary for this optically-driven process.

Additionally, spectroscopic measurements could be easily integrated to study in situ nanowire growth dynamics. However, in all the included demonstrations of nanowire growth through batch-processes—both quartz cuvette and NMR tubes as reaction vessels—the nanowire growth solution developed convective patterns due to photothermal heating and variations in intensity across the Gaussian laser source. In order to realize the greater potential of this contact-free, colloidal-based semiconductor nanowire growth process, a reaction scheme to circumvent problems associated with free convection was developed.

Continuous Flow Photothermal Nanowire Growth Here, as a proof of principle, the photothermaily-driven growth of semiconductor nanowires was demonstrated while operating under a continuous flow configuration. An optically interrogable reaction zone (FIG. 9A-D) was constructed, through which II-VI ionic precursors and nanocrystals were simultaneously injected. Upon irradiation and while under flow, the nanocrystals rapidly generated heat to decompose the precursor, grow nanowires (FIGS. 9D-9E), and exit from the flow cell. Converting this non-contact, laser-driven growth into a continuous flow process is a step closer towards building a low-cost, scalable system in which nanowire growth dynamics and various growth parameters can be rapidly scanned and spectroscopically probed to enable real-time feedback and optimization of material properties.

For a typical continuous flow-based, photothermally-driven nanowire growth synthesis, a glass tube with an inner diameter, outer diameter, and length of 4 mm, 5 mm, and 95 mm, respectively, was sealed under a nitrogen atmosphere with two small rubber septa. The reaction vessel was pre-filled with degassed 1-octadecene to displace all nitrogen prior to injection of the nanowire growth solution. The nanowire precursor growth solution, consisting of 60 μL of a Bi NC dispersion (1.34 mmol/L), 750 μL of Cd-oleate (0.15 M), 1.3 mL of TOP:Se (1.0 M), and 240 μL of degassed 1-ODE, was prepared in a nitrogen-filled glove box and loaded into a syringe. The needle of the precursor syringe was inserted through a rubber septum leading into the reaction vessel and the syringe was fixed onto a syringe pump in order to control the flow rate (5 mL/hr). A second needle was inserted into the other rubber septum on the exit side of the reaction vessel, leading to a glass vial to collect the nanowire product. Prior to injecting the nanowire precursor growth solution, the laser was aligned to irradiate the center of the reaction vessel. After injecting the glass reactor vessel with the nanowire precursor solution, the reactor was irradiated with a high-power, polarized near infrared fiber laser (λ=1070 nm) at 5 W. The product was washed with a 2:1:1 ratio of toluene:chloroform:ethanol, collected by centrifugation at 19000 RCF, redispersed in toluene, and washed two more times prior to sample characterization.

Unlike for the rectangular cuvette, heat transport coefficient correlations exist for the horizontal cylinder geometry, and the internal temperatures during laser-driven nanowire growth could be calculated. At these low flow rates, the Peclet number is ˜1, which means both thermal conduction of heat and fluid flow of heat are both important and cannot be neglected. The axial diffusion of heat both upstream and downstream of the incident laser spot reflects this Peclet number (FIGS. 9F-9G). FIGS. 9F-9H show the projected temperature distribution on the surface of the flow cell. This analysis shows that there is little radial temperature distribution, and, unlike with the cuvette, the infrared thermography images are within 1% of the internal temperatures, suggesting that the maximum temperature during growth was ˜188° C., which is below the typical 230° C. temperature used for bismuth-seeded CdSe nanowire synthesis. In addition, these results demonstrate that a flow cell geometry can be useful for in situ spectroscopic experiments. Analytical temperature distributions of both a bismuth-seeded CdSe nanowire and a bismuth nanocrystal in an infinite bath did not demonstrate appreciable heating above ambient temperatures. Thus, the decreased temperature requirement for nanowire synthesis could be due to local heating of the nanowire due to exothermic precursor decomposition or hot electron effects. To examine these, bismuth nanocrystals were heated in a cuvette and measured the surface temperatures with CdSe precursors (FIGS. 3A-D) and without CdSe precursors (FIGS. 3E-H). The surfaces of the cuvettes containing the irradiated nanocrystal solutions with CdSe precursors were 96° C. higher in temperature than the cuvettes without CdSe precursors after 540 seconds. This demonstrates heating associated with the decomposition of CdSe precursors, which can accelerate nanowire synthesis. Alternatively, the growth of nanowires can cause scattering effects that could boost the absorption of light.

Overall, heat can be generated rapidly by irradiating colloidal, low-melting point nanocrystals such as bismuth and indium. This fast, contact-free heating has been leveraged to drive precursor competition, diffusion of the semiconductor atom into the metal seed, and nanowire growth. A range of metal/semiconductor combinations were studied for this optically-driven process to grow both ionic and covalent nanowires. Moreover, this process is readily converted from a batch process performed on a benchtop in a cuvette to a low-cost, scalable continuous-flow process on the benchtop. In addition, the ability to quickly reach high temperatures near the metal nanocrystal seed could enable semiconductor NW doping during the growth process, rather than adding a post-synthesis doping step.

The photothermal heating of metallic nanocrystals during continuous-wave NIR laser irradiation was capable of synthesizing both ionic and covalent semiconductor nanowires in solution under continuous flow conditions. This was achieved by utilizing the large optical absorption coefficients of metal nanocrystals to generate sufficient heat to facilitate solution-liquid-solid nanowire synthesis. Because the metal nanocrystals are dispersed freely in solution and are heated collectively, they have the potential to reach very high temperatures due to Young-Laplace interfacial surface pressures. With further optimization, this optically-driven nanowire growth process could enable solution-based growth that currently is not possible with conventional methods due to solvent boiling point limitations.

In addition, photothermal heating makes rapid changes in temperature possible, which could facilitate the production of complex, heterostructured NWs or rational dopant incorporation via solution-based methods. Moreover, because this process can be performed on a benchtop in virtually any chemical-resistive, optically interrogable reaction vessel, it can provide optical access during solution-based NW growth, allowing for in situ characterization through scattering and spectroscopic measurements.

While illustrative embodiments have been illustrated and described, it will be appreciated that various changes can be made therein without departing from the spirit and scope of the disclosure.

1. A method of growing a nanostructure, comprising:
suspending a plurality of particles in a fluid;
providing a soluble nanostructure precursor in the fluid;
irradiating at least one particle with an incident electromagnetic radiation having a wavelength of from 300 nm to 15,000 nm; and
reacting the soluble nanostructure precursor to grow a nanostructure from a surface of the irradiated particle,
wherein the plurality of particles is configured to absorb the incident electromagnetic radiation and to transduce the electromagnetic radiation to localized heat; and wherein the plurality of particles comprises nanoparticles, microparticles, or a combination thereof, and
wherein the nanostructure comprises a nanowire, a nanotube, or a combination thereof.

2. The method of claim 1, wherein the particles have a maximum diameter of 2 nm or more to 1 μm or less.

3. (canceled)

4. The method of claim 1, wherein the particles comprise a plasmonic semiconductor, a metal, a metal alloy, or any combination thereof.

5. The method of claim 1, wherein the particles have an absorption coefficient of 10⁻³ cm⁻¹ or more at the incident electromagnetic radiation wavelength.

6. The method of claim 1, wherein the particles comprise a metal, a metal chalcogenide; a ternary chalcogenide; a quaternary chalcogenide, or any combination thereof.

7. (canceled)

8. The method of claim 1, wherein the particle is a liquid during irradiation and growth of the nanostructure.

9. The method of claim 1, wherein irradiating the at least one particle heats a surface of the irradiated particle to a greater temperature than the temperature of the fluid bulk.

10. The method of claim 1, wherein the nanostructure precursor is dissolved in the fluid.

11. The method of claim 1, wherein the nanostructure precursor comprises an organometallic compound, a diamine-dithiol mixture including a dissolved bulk Group (V)₂-Group (VI)₃ chalcogenide, or any combination thereof.

12. The method of claim 1, wherein the nanostructure comprises an insulator, metal, or semiconductor.

13. The method of claim 1, wherein the nanostructure comprises group IV elements, metal chalcogenides, metal pnictides, or any combination thereof.

14. The method of claim 1, wherein the fluid comprises an organic solvent, or a mixture of an organic solvent and water.

15. (canceled)

16. The method of claim 1, wherein the fluid comprises an aqueous solvent.

17. The method of claim 1, further comprising introducing a dopant precursor to the fluid and irradiating the at least one particle with an incident electromagnetic radiation having a wavelength of from 300 nm to 15,000 nm to provide a doped nanostructure, wherein wavelength of the incident electromagnetic radiation is optionally variable.

18-20. (canceled)

21. The method of claim 1, further comprising continuously flowing the fluid through a reactor, and irradiating the at least one particle with the incident electromagnetic radiation at a predetermined location in the reactor.

22. The method of claim 1, comprising growing the nanostructure under atmospheric pressure.

23. The method of claim 1, comprising growing the nanostructure in an oxygen-free atmosphere.

24. A method of growing a nanostructure, comprising:
continuously flowing a fluid through a reactor, the fluid comprising a plurality of particles and a nanostructure precursor;
irradiating at least one particle with an incident electromagnetic radiation having a wavelength of from 300 nm to 15,000 nm at a predetermined location in the reactor, wherein the plurality of particles is configured to absorb the incident electromagnetic radiation and to transduce the electromagnetic radiation to heat;
reacting the nanostructure precursor to grow a nanostructure from a surface of the irradiated particle, and
wherein the nanostructure comprises a nanowire, a nanotube, or a combination thereof.

25. A nanostructure made according to a method of claim 1.

26. The nanostructure of claim 25, wherein the nanostructure has an aspect ratio of from 2:1 to 100,000:1.
